(19) United States
(12) Patent Application Publication
(10) Pub. No.: US 2026/0254349 A1
(43) Pub. Date: Aug. 27, 2026

(54) INVERTER SYSTEM

(71) Applicant: TOYOTA JIDOSHA KABUSHIKI KAISHA, Toyota-shi (JP)

(72) Inventor: Yosuke SUZUKI, Hadano-shi (JP)

(73) Assignee: TOYOTA JIDOSHA KABUSHIKI KAISHA, Toyota-shi (JP)

(21) Appl. No.: 19/448,396

(22) Filed: Jan. 14, 2026

(30) Foreign Application Priority Data
Feb. 26, 2025 (JP) 2025-029501

(51) Int. Cl. H02M 1/32; H02M 7/483; H02M 7/537; B60L 3/00

(52) U.S. Cl. CPC H02M 1/325; H02M 7/483; H02M 7/537; B60L 3/003; B60L 2210/42

(57) ABSTRACT

An inverter system includes an inverter that converts a direct current voltage into voltages of three different levels and outputs three-phase alternating current power, and a control device that controls the inverter. The inverter includes a first switching element provided between a connection position of a first capacitor and a connection position of three upper arm elements in a high-potential wiring line. In a case where it is determined that at least one of the three upper arm elements has a short-circuit failure, the control device controls the first switching element to interrupt a portion between the connection position of the first capacitor and the connection position of the three upper arm elements in the high-potential wiring line.

### CROSS-REFERENCE TO RELATED APPLICATION

This application claims priority to Japanese Patent Application No. 2025-029501 filed on February 26, 2025. The disclosure of the above-identified application, including the specification, drawings, and claims, is incorporated by reference herein in its entirety.

### BACKGROUND

### 1. Technical Field

The present disclosure relates to an inverter system that is mounted in a vehicle.

### 2. Description of Related Art

As an inverter that is mounted in a vehicle, a three-level inverter that converts direct current power output by a battery into three-phase alternating current power is known (for example, refer to Japanese Unexamined Patent Application Publication No. 2024-101332 (JP 2024-101332 A)).

### SUMMARY

An object of the present disclosure is to provide an inverter system capable of improving limp home performance of a vehicle.

A first aspect of the present disclosure is an inverter system including: an inverter configured to convert a direct current voltage into voltages of three different levels and output three-phase alternating current power; and a control device configured to control the inverter, in which: the inverter includes a high-potential wiring line that is connected to a positive electrode of a power supply, a low-potential wiring line that is connected to a negative electrode of the power supply, at least one neutral point having a potential between a potential of the high-potential wiring line and a potential of the low-potential wiring line, a first capacitor connected between the high-potential wiring line and the neutral point, a second capacitor connected between the neutral point and the low-potential wiring line, three upper arm elements corresponding to respective three phases, three lower arm elements corresponding to the respective three phases, three middle elements corresponding to the respective three phases, and a first switch element provided between a connection position of the first capacitor and a connection position of the three upper arm elements in the high-potential wiring line, the first switch element being configured to switch conduction and interruption in the high-potential wiring line; and the control device is configured to execute determining whether at least one of the three upper arm elements fails, and controlling, in accordance with determining that at least one of the three upper arm elements fails, the first switch element such that there is an interruption in the high-potential wiring line.

A second aspect of the present disclosure is an inverter system including: an inverter configured to convert a direct current voltage into voltages of three different levels and output three-phase alternating current power; and a control device configured to control the inverter, in which: the inverter includes a high-potential wiring line that is connected to a positive electrode of a power supply, a low-potential wiring line that is connected to a negative electrode of the power supply, at least one neutral point having a potential between a potential of the high-potential wiring line and a potential of the low-potential wiring line, a first capacitor connected between the high-potential wiring line and the neutral point, a second capacitor connected between the neutral point and the low-potential wiring line, three upper arm elements corresponding to respective three phases, three lower arm elements corresponding to the respective three phases, three middle elements corresponding to the respective three phases, and a second switch element provided between a connection position of the second capacitor and a connection position of the three lower arm elements in the low-potential wiring line, the second switch element being configured to switch conduction and interruption in the low-potential wiring line; and the control device is configured to execute determining whether at least one of the three lower arm elements fails, and controlling, in accordance with determining that at least one of the three lower arm elements fails, the second switch element such that there is an interruption in the low-potential wiring line.

According to the present disclosure, it is possible to provide an inverter system capable of improving limp home performance of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a schematic configuration of an inverter system in an embodiment;

FIG. 2 is a diagram showing an example of a circuit configuration of an inverter in the embodiment;

FIG. 3 is a block diagram schematically showing an example of a hardware configuration of the inverter system in the embodiment;

FIG. 4 is a diagram for describing an operation of a first switch in a case where an upper arm element is short-circuited in the embodiment;

FIG. 5 is a diagram for describing an operation of a second switch in a case where a lower arm element is short-circuited in the embodiment; and

FIG. 6 is a flowchart showing an example of a processing routine executed by an ECU in the embodiment.

### DETAILED DESCRIPTION OF EMBODIMENTS

A three-phase three-level inverter is known as an inverter mounted in a vehicle such as a BEV, an HEV, or a PHEV. In such an inverter, in a case where an upper arm element or a lower arm element is short-circuited, a middle element is also short-circuited in a case where the middle element is turned on. As a result, the inverter cannot perform an operation of using the middle element in addition to an operation of using the failed upper arm element or lower arm element. As a result, there is a problem that limp home performance of the vehicle is deteriorated. The present disclosure solves the problem.

According to a first aspect of the present disclosure, there is provided an inverter system including: an inverter that converts a direct current voltage into voltages of three different levels and outputs three-phase alternating current power; and a control device that controls the inverter. In the first aspect of the present disclosure, the inverter includes a first switching element. The first switching element is provided between a connection position of a first capacitor and a connection position of three upper arm elements in a high-potential wiring line of the inverter and is configured to switch conduction and interruption of the high-potential wiring line. In addition, in the first aspect of the present disclosure, the control device is configured to execute determining whether at least one of the three upper arm elements fails. In addition, in the first aspect of the present disclosure, the control device is configured to execute controlling the first switching element to interrupt the high-potential wiring line in accordance with the determination that at least one of the three upper arm elements fails.

According to the first aspect of the present disclosure, in a case where at least one of the three upper arm elements is short-circuited, the first switching element interrupts the high-potential wiring line between the first capacitor and the three upper arm elements. Therefore, even in a case where the middle element is turned on, it is possible to prevent the middle element from being short-circuited. As a result, the inverter can also perform an operation of using the middle element in addition to an operation of using the lower arm element. Therefore, it is possible to improve the limp home performance of the vehicle.

In addition, according to a second aspect of the present disclosure, there is provided an inverter system including: an inverter that converts a direct current voltage into voltages of three different levels and outputs three-phase alternating current power; and a control device that controls the inverter. In the second aspect of the present disclosure, the inverter includes a second switching element. The second switching element is provided between a connection position of a second capacitor and a connection position of three lower arm elements in a low-potential wiring line of the inverter and is configured to switch conduction and interruption of the low-potential wiring line. In addition, in the second aspect of the present disclosure, the control device is configured to execute determining whether at least one of the three lower arm elements fails. In addition, in the second aspect of the present disclosure, the control device is configured to execute controlling the second switching element to interrupt the low-potential wiring line in accordance with the determination that at least one of the three lower arm elements fails.

According to the second aspect of the present disclosure, in a case where at least one of the three lower arm elements is short-circuited, the second switching element interrupts the low-potential wiring line between the second capacitor and the three lower arm elements. Therefore, even in a case where the middle element is turned on, it is possible to prevent the middle element from being short-circuited. As a result, the inverter 11 can also perform an operation of using the middle element in addition to an operation of using the upper arm element. Therefore, it is possible to improve the limp home performance of the vehicle.

### Embodiment

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure.

### Outline of Inverter System

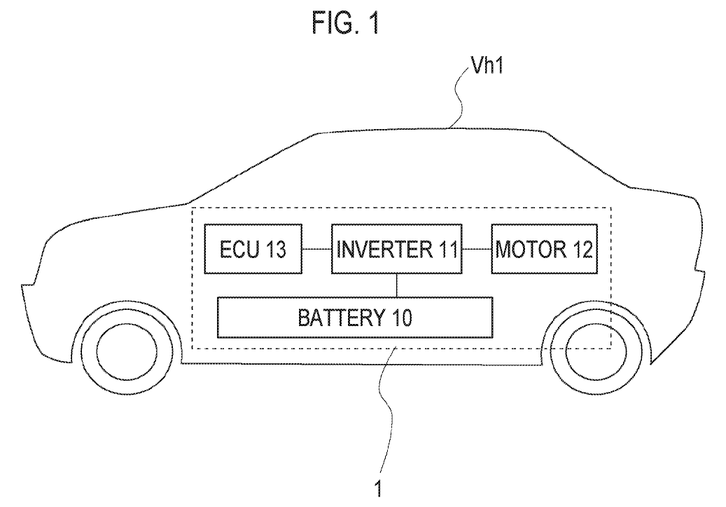

In the present embodiment, an example of applying an inverter system according to the present disclosure to a vehicle will be described. FIG. 1 is a diagram schematically showing an example of a schematic configuration of an inverter system 1 in the present embodiment. The inverter system 1 in the present embodiment is mounted in a vehicle Vh1. The vehicle Vh1 may be a BEV, an HEV, or a PHEV. The inverter system 1 is configured to include a battery 10, an inverter 11, a motor 12, and an ECU 13.

The battery 10 is a secondary battery that outputs direct current power, and is an example of a "power supply" according to the present disclosure. In the example, the battery 10 may be a lithium ion battery. The battery 10 is not limited to the lithium ion battery, and may be a nickel hydrogen battery, a nickel cadmium battery, an all-solid state battery, or the like. The motor 12 is a three-phase AC motor that functions as a prime mover of the vehicle Vh1. The inverter 11 is disposed between the battery 10 and the motor 12, converts direct current power output from the battery 10 into three-phase alternating current power, and supplies the converted three-phase alternating current power to the motor 12. As a result, the motor 12 drives a wheel of the vehicle Vh1, and the vehicle Vh1 travels. The ECU 13 is a computer that controls the inverter 11 in accordance with a driving condition of the vehicle Vh1.

### Circuit Configuration of Inverter

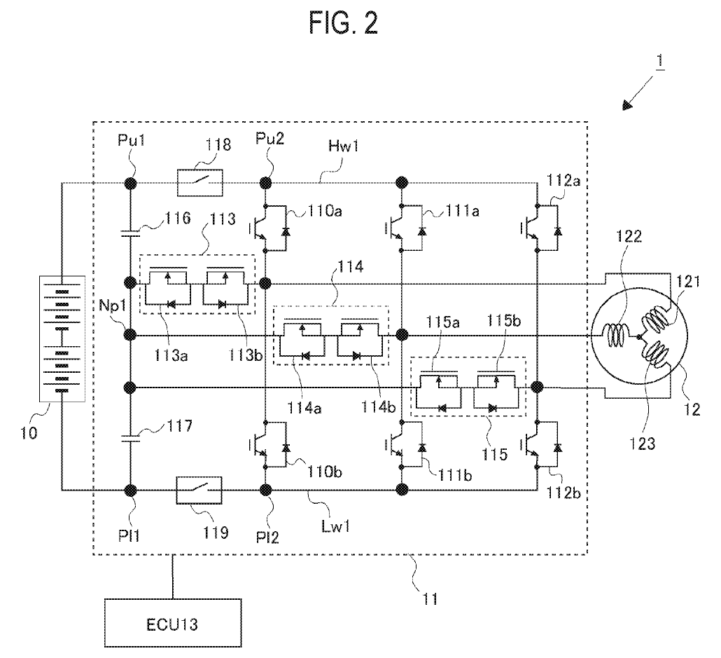

FIG. 2 is a diagram showing an example of a circuit configuration of the inverter 11 in the present embodiment. The inverter 11 in the present embodiment is a three-level T-type inverter. As shown in FIG. 2, the inverter 11 includes a high-potential wiring line Hw1, a neutral point Np1, a low-potential wiring line Lw1, a first capacitor 116, and a second capacitor 117. The high-potential wiring line Hw1 is connected to a positive electrode of the battery 10 (power supply). The low-potential wiring line Lw1 is connected to a negative electrode of the battery 10. The first capacitor 116 is connected between the high-potential wiring line Hw1 and the neutral point Np1. The second capacitor 117 is connected between the neutral point Np1 and the low-potential wiring line Lw1. The first capacitor 116 and the second capacitor 117 are smoothing capacitors that stabilize a voltage of the neutral point Np1 and reduce a current ripple.

In addition, the inverter 11 in the present embodiment includes a first switching element 110a, a second switching element 110b, a third switching element 111a, a fourth switching element 111b, a fifth switching element 112a, and a sixth switching element 112b. In the example, the first switching element 110a, the second switching element 110b, the third switching element 111a, the fourth switching element 111b, the fifth switching element 112a, and the sixth switching element 112b may be configured to include an arm element having an IGBT and a free-wheeling diode connected parallel to the IGBT. In the following description, the first switching element 110a, the second switching element 110b, the third switching element 111a, the fourth switching element 111b, the fifth switching element 112a, and the sixth switching element 112b may be referred to as a "switching element 1100".

The first switching element 110a and the second switching element 110b are connected in series between the high-potential wiring line Hw1 and the low-potential wiring line Lw1. In this case, a drain terminal of the first switching element 110a is connected to the high-potential wiring line Hw1, and a source terminal of the second switching element 110b is connected to the low-potential wiring line Lw1. In addition, a source terminal of the first switching element 110a and a drain terminal of the second switching element 110b are connected to a U-phase coil 121 of the motor 12. The first switching element 110a and the second switching element 110b may be referred to as a U-phase upper arm element and a U-phase lower arm element, respectively.

The third switching element 111a and the fourth switching element 111b are connected in series between the high-potential wiring line Hw1 and the low-potential wiring line Lw1. In this case, a drain terminal of the third switching element 111a is connected to the high-potential wiring line Hw1, and a source terminal of the fourth switching element 111b is connected to the low-potential wiring line Lw1. In addition, a source terminal of the third switching element 111a and a drain terminal of the fourth switching element 111b are connected to a V-phase coil 122 of the motor 12. The third switching element 111a and the fourth switching element 111b may be referred to as a V-phase upper arm element and a V-phase lower arm element, respectively.

The fifth switching element 112a and the sixth switching element 112b are connected in series between the high-potential wiring line Hw1 and the low-potential wiring line Lw1. In this case, a drain terminal of the fifth switching element 112a is connected to the high-potential wiring line Hw1, and a source terminal of the sixth switching element 112b is connected to the low-potential wiring line Lw1. In addition, a source terminal of the fifth switching element 112a and a drain terminal of the sixth switching element 112b are connected to a W-phase coil 123 of the motor 12. The fifth switching element 112a and the sixth switching element 112b may be referred to as a W-phase upper arm element and a W-phase lower arm element, respectively.

The first switching element 110a, the third switching element 111a, and the fifth switching element 112a in the present embodiment are examples of an "upper arm element" according to the present disclosure. In addition, the second switching element 110b, the fourth switching element 111b, and the sixth switching element 112b in the present embodiment are examples of a "lower arm element" according to the present disclosure.

In addition, the inverter 11 in the present embodiment includes a first middle element portion 113, a second middle element portion 114, and a third middle element portion 115. Each of the first middle element portion 113, the second middle element portion 114, and the third middle element portion 115 is configured to include two switching elements. Each of the two switching elements may be configured in the same manner as the switching element 1100.

The first middle element portion 113 includes a first U-phase middle element 113a and a second U-phase middle element 113b as the two switching elements. A drain terminal of the first U-phase middle element 113a is connected to the neutral point Np1. A source terminal of the first U-phase middle element 113a is connected to a source terminal of the second U-phase middle element 113b. A drain terminal of the second U-phase middle element 113b is connected to the source terminal of the first switching element 110a and the drain terminal of the second switching element 110b. In other words, the drain terminal of the second U-phase middle element 113b is connected to the U-phase coil 121 of the motor 12. The first middle element portion 113 may be referred to as a U-phase middle element.

The second middle element portion 114 includes a first V-phase middle element 114a and a second V-phase middle element 114b as the two switching elements. A drain terminal of the first V-phase middle element 114a is connected to the neutral point Np1. A source terminal of the first V-phase middle element 114a is connected to a source terminal of the second V-phase middle element 114b. A drain terminal of the second V-phase middle element 114b is connected to the source terminal of the second switching element 110b and a drain terminal of the third switching element 111a. In other words, the drain terminal of the second V-phase middle element 114b is connected to the V-phase coil 122 of the motor 12. The second middle element portion 114 may be referred to as a V-phase middle element.

The third middle element portion 115 includes a first W-phase middle element 115a and a second W-phase middle element 115b as the two switching elements. A drain terminal of the first W-phase middle element 115a is connected to the neutral point Np1. A source terminal of the first W-phase middle element 115a is connected to a source terminal of the second W-phase middle element 115b. A drain terminal of the second W-phase middle element 115b is connected to a source terminal of the fifth switching element 112a and a drain terminal of the sixth switching element 112b. In other words, the drain terminal of the second W-phase middle element 115b is connected to the W-phase coil 123 of the motor 12. The third middle element portion 115 may be referred to as a W-phase middle element.

The first middle element portion 113, the second middle element portion 114, and the third middle element portion 115 in the present embodiment are examples of a "middle element" according to the present disclosure.

The ECU 13 controls the inverter 11 in accordance with a driving state of the motor 12. In the example, the ECU 13 is connected to a gate terminal of each of the 12 switching elements shown in FIG. 2 and switches on and off of each switching element. The 12 switching elements shown in FIG. 2 are the first switching element 110a, the second switching element 110b, the third switching element 111a, the fourth switching element 111b, the fifth switching element 112a, the sixth switching element 112b, the first U-phase middle element 113a, the second U-phase middle element 113b, the first V-phase middle element 114a, the second V-phase middle element 114b, the first W-phase middle element 115a, and the second W-phase middle element 115b. Specifically, the ECU 13 switches on and off of each switching element in accordance with an operation mode of the inverter 11. The operation modes of the inverter 11 include the following first mode, second mode, and third mode.

In the first mode, the ECU 13 controls the inverter 11 such that the upper arm element is turned on, the middle element is turned off, and the lower arm element is turned off. The upper arm element is the first switching element 110a, the third switching element 111a, and the fifth switching element 112a. The middle element is the first middle element portion 113, the second middle element portion 114, and the third middle element portion 115. The lower arm element is the second switching element 110b, the fourth switching element 111b, and the sixth switching element 112b. In this case, each of coils 121 to 123 of the motor 12 is conductive to the high-potential wiring line Hw1 of the inverter 11.

In the second mode, the ECU 13 controls the inverter 11 such that the upper arm element is turned off, the middle element is turned on, and the lower arm element is turned off. The upper arm element is the first switching element 110a, the third switching element 111a, and the fifth switching element 112a. The middle element is the first middle element portion 113, the second middle element portion 114, and the third middle element portion 115. The lower arm element is the second switching element 110b, the fourth switching element 111b, and the sixth switching element 112b. In this case, each of the coils 121 to 123 of the motor 12 is conductive to the neutral point Np1 of the inverter 11.

In the third mode, the ECU 13 controls the inverter 11 such that the upper arm element is turned off, the middle element is turned off, and the lower arm element is turned on. The upper arm element is the first switching element 110a, the third switching element 111a, and the fifth switching element 112a. The middle element is the first middle element portion 113, the second middle element portion 114, and the third middle element portion 115. The lower arm element is the second switching element 110b, the fourth switching element 111b, and the sixth switching element 112b. In this case, each of the coils 121 to 123 of the motor 12 is conductive to the low-potential wiring line Lw1 of the inverter 11.

As described above, the ECU 13 switches the operation mode of the inverter 11, so that three-phase alternating current power can be supplied from the inverter 11 to the motor 12.

In addition to the above-described components, the inverter 11 in the present embodiment includes a first switch 118 and a second switch 119. The first switch 118 is disposed between the connection position (Pu1 in FIG. 2) of the first capacitor 116 and the connection position (Pu2 in FIG. 2) of the first switching element 110a (drain terminal) in the high-potential wiring line Hw1. The first switch 118 is a switch that switches conduction and interruption of the high-potential wiring line Hw1, and is an example of a "first switching element" according to the present disclosure. In the example, the first switch 118 may be a single-pole single-throw switch. In the following description, the high-potential wiring line Hw1 is conductive in a case where the first switch 118 is turned on, and the high-potential wiring line Hw1 is interrupted in a case where the first switch 118 is turned off.

The second switch 119 is disposed between the connection position (Pl1 in FIG. 2) of the second capacitor 117 and the connection position (Pl2 in FIG. 2) of the second switching element 110b (source terminal) in the low-potential wiring line Lw1. The second switch 119 is a switch that switches conduction and interruption of the low-potential wiring line Lw1, and is an example of a "second switching element" according to the present disclosure. In the example, the second switch 119 may be a single-pole single-throw switch similar to the first switch 118. In the following description, the low-potential wiring line Lw1 is conductive in a case where the second switch 119 is turned on, and the low-potential wiring line Lw1 is interrupted in a case where the second switch 119 is turned off.

The first switch 118 and the second switch 119 are controlled by the ECU 13. The control of the first switch 118 and the second switch 119 will be described later.

### Hardware Configuration of Inverter System

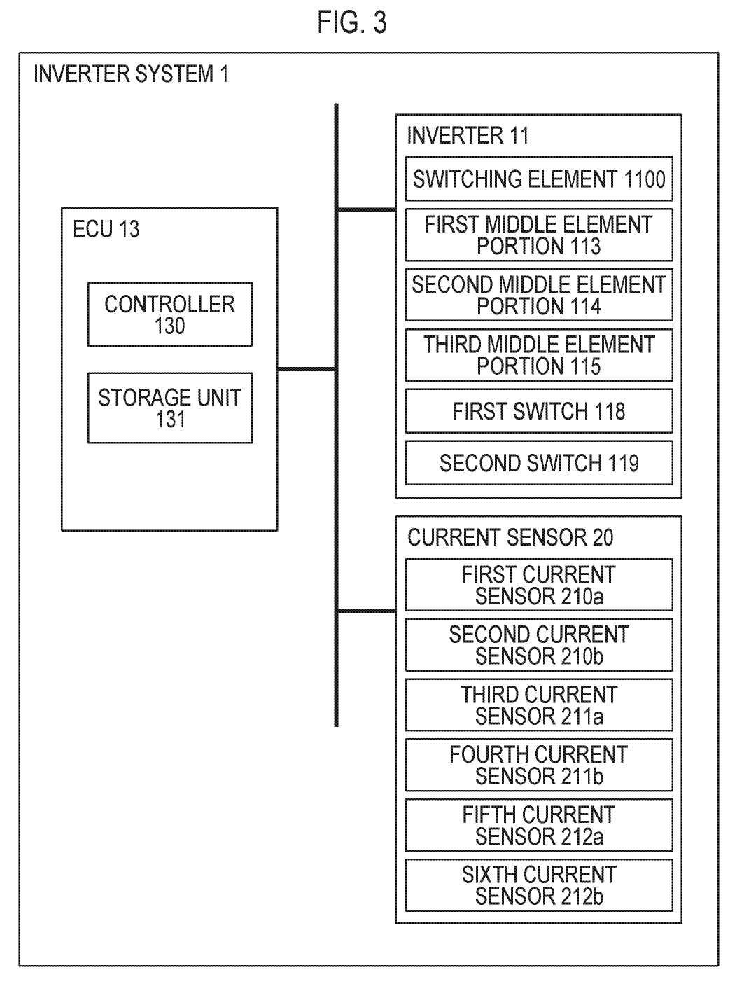

FIG. 3 is a block diagram schematically showing an example of a hardware configuration of the inverter system 1. The inverter system 1 in the present embodiment includes the inverter 11, a current sensor 20, and the ECU 13. The inverter 11, the current sensor 20, and the ECU 13 are connected to each other by an in-vehicle network. The in-vehicle network may be a network based on a standard such as controller area network (CAN), local interconnect network (LIN), or FlexRay.

The inverter 11 includes the switching element 1100, the first middle element portion 113, the second middle element portion 114, the third middle element portion 115, the first switch 118, and the second switch 119. The switching element 1100 is the first switching element 110a, the second switching element 110b, the third switching element 111a, the fourth switching element 111b, the fifth switching element 112a, and the sixth switching element 112b. The switching element 1100 is the first switching element 110a, the second switching element 110b, the third switching element 111a, the fourth switching element 111b, the fifth switching element 112a, and the sixth switching element 112b. The first middle element portion 113 is the first U-phase middle element 113a and the second U-phase middle element 113b. The second middle element portion 114 is the first V-phase middle element 114a and the second V-phase middle element 114b. The third middle element portion 115 is the first W-phase middle element 115a and the second W-phase middle element 115b. The functions of the switching element 1100, the first middle element portion 113, the second middle element portion 114, and the third middle element portion 115 are as described above.

The current sensor 20 detects a current value flowing through each of the six switching elements included in the switching element 1100. Specifically, the current sensor 20 is configured to include a first current sensor 210a that detects a current value flowing through the first switching element 110a and a second current sensor 210b that detects a current value flowing through the second switching element 110b. The current sensor 20 is configured to include a third current sensor 211a that detects a current value flowing through the third switching element 111a and a fourth current sensor 211b that detects a current value flowing through the fourth switching element 111b. The current sensor 20 is configured to include a fifth current sensor 212a that detects a current value flowing through the fifth switching element 112a and a sixth current sensor 212b that detects a current value flowing through the sixth switching element 112b.

The ECU 13 can be configured as a computer having a processor (CPU, GPU, or the like), a main memory (RAM, ROM, or the like), and an auxiliary memory (EPROM, hard disk drive, removable media, or the like). Various programs, various tables, an operating system (OS), and the like are stored in the auxiliary memory, and each function of the ECU 13 is realized by the processor executing the program stored therein, as will be described later. However, some or all of the functions may be realized as a hardware module by, for example, a hardware circuit such as an ASIC or an FPGA. The ECU 13 in the present embodiment is an example of a "control device" according to the present disclosure.

The ECU 13 in the present embodiment includes a controller 130 and a storage unit 131. The controller 130 is an operation unit that realizes various functions of the ECU 13 by executing a predetermined program stored in the auxiliary memory. The controller 130 can be realized by, for example, a hardware processor such as a CPU. In addition, the controller 130 may be configured to include a RAM, a ROM, a cache memory, and the like. The function realized by the controller 130 will be described later.

The storage unit 131 is a unit that stores various types of information, and is configured by a storage medium such as a RAM, a magnetic disk, and a flash memory. The storage unit 131 stores a predetermined program executed by the controller 130, data used by the program, and the like.

Various sensors for acquiring sensor data used for controlling the inverter 11 are also connected to the ECU 13. The sensors may include, for example, a sensor that detects an operation amount of an accelerator pedal, a sensor that detects a traveling speed of the vehicle Vh1, and a sensor that detects an acceleration of the vehicle Vh1. The sensors may include, for example, a sensor that detects an operation amount of a brake pedal, a sensor that detects a shift position, and a sensor that detects a rotation speed of the motor 12. The sensors may include, for example, a sensor that detects a remaining power of the battery 10 and a sensor that detects a temperature of the battery 10.

In the inverter system 1 configured as described above, the controller 130 of the ECU 13 switches the operation mode of the inverter 11 in accordance with the sensor data as described above. The operation modes of the inverter 11 include the first mode, the second mode, and the third mode described above.

In addition, in the inverter system 1 in the present embodiment, the controller 130 of the ECU 13 controls the first switch 118 to be turned on in a case where the upper arm element is normal, and controls the first switch 118 to be turned off in a case where the upper arm element fails. The upper arm element is the first switching element 110a, the third switching element 111a, and the fifth switching element 112a. The failure of the upper arm element referred herein is a failure (short-circuit failure) in which a current flows through the upper arm element even though the upper arm element is controlled to be turned off.

The short-circuit failure of the upper arm element is determined in accordance with the current value detected by each of the first current sensor 210a, the third current sensor 211a, and the fifth current sensor 212a in a case where the inverter 11 operates in the second mode or the third mode (in a case where the upper arm element is controlled to be turned off). In the example, in a case where the inverter 11 operates in the second mode or the third mode, and at least one of the first current sensor 210a, the third current sensor 211a, or the fifth current sensor 212a detects a current value larger than a predetermined threshold value (for example, 0 amperes), the controller 130 may determine that at least one of the three upper arm elements is short-circuited.

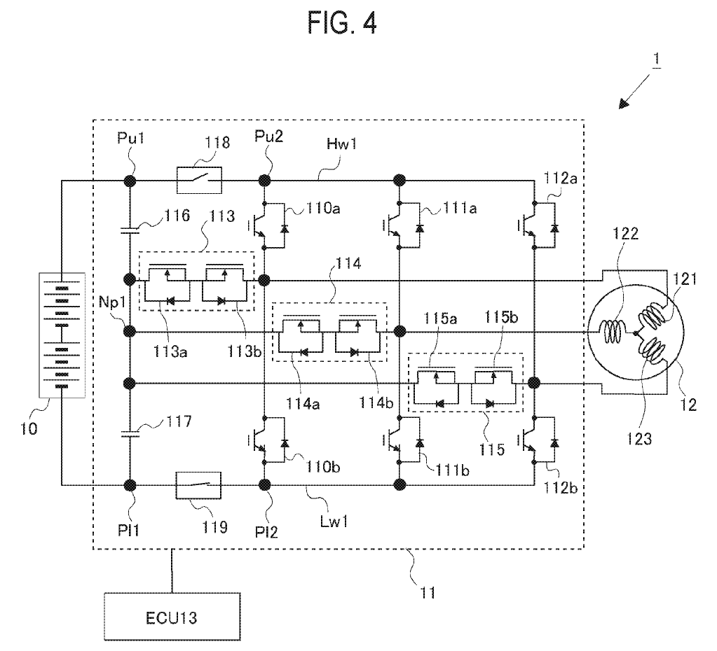

In a case where the short-circuit failure of at least one of the three upper arm elements is detected as described above, the controller 130 switches the first switch 118 from on to off as shown in FIG. 4. As a result, even in a case where the middle element is turned on in a state where the upper arm element is short-circuited, it is possible to prevent the middle element from being short-circuited. As a result, the inverter 11 can operate in the second mode and the third mode.

In addition, in the inverter system 1 in the present embodiment, the controller 130 of the ECU 13 controls the second switch 119 to be turned on in a case where the lower arm element is normal, and controls the second switch 119 to be turned off in a case where the lower arm element fails. The lower arm element is the second switching element 110b, the fourth switching element 111b, and the sixth switching element 112b. The failure of the lower arm element referred herein may be a short-circuit failure.

The short-circuit failure of the lower arm element is determined in accordance with the current value detected by each of the first current sensor 210a, the third current sensor 211a, and the fifth current sensor 212a in a case where the inverter 11 operates in the first mode or the second mode (in a case where the upper arm element is controlled to be turned off). In the example, in a case where the inverter 11 operates in the second mode or the third mode, and at least one of the first current sensor 210a, the third current sensor 211a, or the fifth current sensor 212a detects a current value larger than a predetermined threshold value (for example, 0 amperes), the controller 130 may determine that at least one of the three upper arm elements is short-circuited.

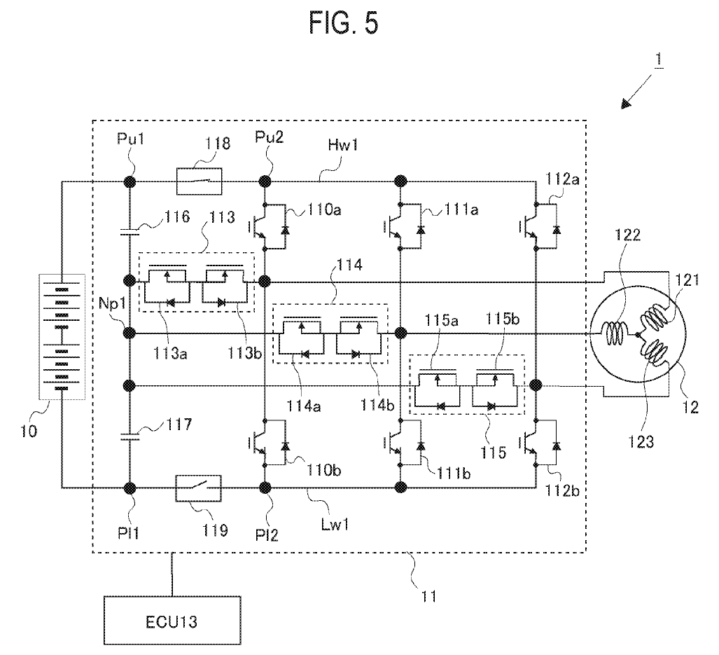

In a case where the short-circuit failure of at least one of the three lower arm elements is detected as described above, the controller 130 switches the second switch 119 from on to off as shown in FIG. 5. As a result, even in a case where the middle element is turned on in a state in which the lower arm element is short-circuited, it is possible to prevent the middle element from being short-circuited. As a result, the inverter 11 can operate in the first mode and the second mode.

### Operation of ECU

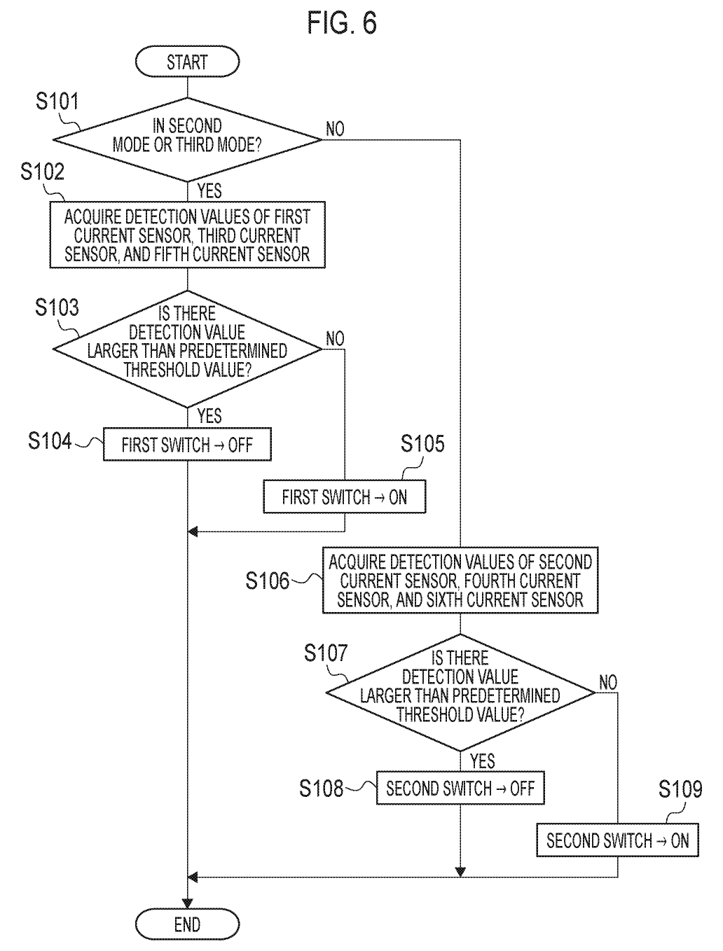

Here, an operation of the ECU 13 in the present embodiment will be described with reference to FIG. 6. FIG. 6 is a flowchart showing an example of a processing routine that is repeatedly executed by the ECU 13 in a predetermined period (for example, about several hundred microseconds to several tens of milliseconds) during the start of the vehicle Vh1 (during the operation of the inverter 11).

In the processing routine of FIG. 6, first, the controller 130 of the ECU 13 determines whether the inverter 11 operates in the second mode or the third mode (S101). In a case where the inverter 11 operates in the second mode or the third mode (affirmative determination in S101), the upper arm element is controlled to be in an off state, so that it is possible to detect the short-circuit failure of the upper arm element. The upper arm element is the first switching element 110a, the third switching element 111a, and the fifth switching element 112a. Therefore, the controller 130 executes the determination processing of whether the upper arm element is short-circuited in S102 to S103.

In S102, the controller 130 acquires the current value (detection value) flowing through each of the first switching element 110a, the third switching element 111a, and the fifth switching element 112a through the first current sensor 210a, the third current sensor 211a, and the fifth current sensor 212a.

In S103, the controller 130 determines whether there is a detection value larger than a predetermined threshold value in the detection values of the first current sensor 210a, the third current sensor 211a, and the fifth current sensor 212a. In a case where there is a detection value larger than the predetermined threshold value in the detection values of the first current sensor 210a, the third current sensor 211a, and the fifth current sensor 212a (affirmative determination in S103), among the three upper arm elements, the upper arm element in which the detection value larger than the predetermined threshold value is detected can be regarded as being short-circuited. The three upper arm elements are the first switching element 110a, the third switching element 111a, and the fifth switching element 112a. On the other hand, in a case where there is no detection value larger than the predetermined threshold value in the detection values of the first current sensor 210a, the third current sensor 211a, and the fifth current sensor 212a (negative determination in S103), it can be regarded that none of the three upper arm elements is short-circuited. The three upper arm elements are the first switching element 110a, the third switching element 111a, and the fifth switching element 112a.

In a case where the affirmative determination is made in S103, the controller 130 proceeds to processing of S104 and controls the first switch 118 to be turned off. On the other hand, in a case where the negative determination is made in S103, the controller 130 proceeds to processing of S105 and controls the first switch 118 to be turned on. In a case where the processing of S104 or S105 is executed and ended, the ECU 13 ends the execution of the processing routine of FIG. 6.

In addition, in a case where it is determined in S101 that the inverter 11 operates in the first mode (negative determination in S101), the lower arm element is controlled to be in an off state, so that it is possible to detect the short-circuit failure of the lower arm element. The lower arm element is the second switching element 110b, the fourth switching element 111b, and the sixth switching element 112b. Therefore, the controller 130 executes the determination processing of whether the lower arm element is short-circuited in S106 to S107.

In S106, the controller 130 acquires the current value (detection value) flowing through each of the second switching element 110b, the fourth switching element 111b, and the sixth switching element 112b through the second current sensor 210b, the fourth current sensor 211b, and the sixth current sensor 212b.

In S107, the controller 130 determines whether there is a detection value larger than a predetermined threshold value in the detection values of the second current sensor 210b, the fourth current sensor 211b, and the sixth current sensor 212b. In a case where there is a detection value larger than the predetermined threshold value in the detection values of the second current sensor 210b, the fourth current sensor 211b, and the sixth current sensor 212b (affirmative determination in S107), among the three lower arm elements, the lower arm element in which the detection value larger than the predetermined threshold value is detected can be regarded as being short-circuited. The three lower arm elements are the second switching element 110b, the fourth switching element 111b, and the sixth switching element 112b. On the other hand, in a case where there is no detection value larger than the predetermined threshold value in the detection values of the second current sensor 210b, the fourth current sensor 211b, and the sixth current sensor 212b (negative determination in S107), it can be regarded that none of the three lower arm elements is short-circuited. The three lower arm elements are the second switching element 110b, the fourth switching element 111b, and the sixth switching element 112b.

In a case where the affirmative determination is made in S107, the controller 130 proceeds to processing of S108 and controls the second switch 119 to be turned off. On the other hand, in a case where the negative determination is made in S107, the controller 130 proceeds to processing of S109 and controls the second switch 119 to be turned on. In a case where the processing of S108 or S109 is executed and ended, the ECU 13 ends the execution of the processing routine of FIG. 6.

### Actions and Effects of Embodiment

In the inverter system 1 according to the present embodiment, in a case where at least one of the three upper arm elements of the inverter 11 is short-circuited, the first switch 118 of the inverter 11 is turned off. The three upper arm elements of the inverter 11 are the first switching element 110a, the third switching element 111a, and the fifth switching element 112a. As a result, a portion between the connection position (Pu1 in FIG. 2) of the first capacitor 116 and the connection position (Pu2 in FIG. 2) of the first switching element 110a (drain terminal) in the high-potential wiring line Hw1 is interrupted. As a result, even in a case where the middle element (first middle element portion 113, second middle element portion 114, and third middle element portion 115) of the inverter 11 is turned on, the middle element is not short-circuited. Therefore, in a case where at least one of the three upper arm elements is short-circuited, the inverter 11 can operate in the second mode and the third mode.

In addition, in the inverter system 1 according to the present embodiment, in a case where at least one of the three lower arm elements of the inverter 11 is short-circuited, the second switch 119 of the inverter 11 is turned off. The three lower arm elements of the inverter 11 are the second switching element 110b, the fourth switching element 111b, and the sixth switching element 112b. As a result, a portion between the connection position (Pl1 in FIG. 2) of the second capacitor 117 and the connection position (Pl2 in FIG. 2) of the second switching element 110b (source terminal) in the low-potential wiring line Lw1 is interrupted. As a result, even in a case where the middle element (first middle element portion 113, second middle element portion 114, and third middle element portion 115) of the inverter 11 is turned on, the middle element is not short-circuited. Therefore, in a case where at least one of the three lower arm elements is short-circuited, the inverter 11 can operate in the first mode and the second mode.

Therefore, with the inverter system 1 according to the present embodiment, it is possible to improve limp home performance of the vehicle Vh1 in a case where the upper arm element or the lower arm element of the inverter 11 is short-circuited.

### Modification

In the embodiment described above, an example has been described in which the inverter 11 includes both the first switch 118 and the second switch 119, but the inverter 11 may include only one of the first switch 118 or the second switch 119.

What is claimed is:

1. An inverter system comprising:
an inverter configured to convert a direct current voltage into voltages of three different levels and output three-phase alternating current power; and
a control device configured to control the inverter, wherein:
the inverter includes
a high-potential wiring line that is connected to a positive electrode of a power supply,
a low-potential wiring line that is connected to a negative electrode of the power supply,
at least one neutral point having a potential between a potential of the high-potential wiring line and a potential of the low-potential wiring line,
a first capacitor connected between the high-potential wiring line and the neutral point,
a second capacitor connected between the neutral point and the low-potential wiring line,
three upper arm elements corresponding to respective three phases,
three lower arm elements corresponding to the respective three phases,
three middle elements corresponding to the respective three phases, and
a first switch element provided between a connection position of the first capacitor and a connection position of the three upper arm elements in the high-potential wiring line, the first switch element being configured to switch conduction and interruption in the high-potential wiring line; and
the control device is configured to execute
determining whether at least one of the three upper arm elements fails, and
controlling, in accordance with determining that at least one of the three upper arm elements fails, the first switch element such that there is an interruption in the high-potential wiring line.

2. The inverter system according to claim 1, wherein the determining whether at least one of the three upper arm elements fails includes
determining whether a short-circuit current flows through at least one of the three upper arm elements, and
determining, in accordance with determining that the short-circuit current flows through at least one of the three upper arm elements, that at least one of the three upper arm elements fails.

3. An inverter system comprising:
an inverter configured to convert a direct current voltage into voltages of three different levels and output three-phase alternating current power; and
a control device configured to control the inverter, wherein:
the inverter includes
a high-potential wiring line that is connected to a positive electrode of a power supply,
a low-potential wiring line that is connected to a negative electrode of the power supply,
at least one neutral point having a potential between a potential of the high-potential wiring line and a potential of the low-potential wiring line,
a first capacitor connected between the high-potential wiring line and the neutral point,
a second capacitor connected between the neutral point and the low-potential wiring line,
three upper arm elements corresponding to respective three phases,
three lower arm elements corresponding to the respective three phases,
three middle elements corresponding to the respective three phases, and
a second switch element provided between a connection position of the second capacitor and a connection position of the three lower arm elements in the low-potential wiring line, the second switch element being configured to switch conduction and interruption in the low-potential wiring line; and
the control device is configured to execute
determining whether at least one of the three lower arm elements fails, and
controlling, in accordance with determining that at least one of the three lower arm elements fails, the second switch element such that there is an interruption in the low-potential wiring line.

4. The inverter system according to claim 3, wherein the determining whether at least one of the three lower arm elements fails includes
determining whether a short-circuit current flows through at least one of the three lower arm elements, and
determining, in accordance with determining that the short-circuit current flows through at least one of the three lower arm elements, that at least one of the three lower arm elements fails.
